(19) United States
(12) Patent Application Publication
(10) Pub. No.: US 2008/0242853 A1
(43) Pub. Date: Oct. 2, 2008

(54) Non-grassy, non-beany, low pigment and low micro guar gum and process for making the same

(75) Inventor: Marceliano B. Nieto, Abingdon, MD (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Tic Gums, Inc.

(21) Appl. No.: 12/078,314

(22) Filed: Mar. 28, 2008

Related U.S. Application Data
(60) Provisional application No. 60/907,321, filed on Mar. 28, 2007.

(51) Int. Cl. C08B 37/00; C07G 17/00

(52) U.S. Cl. 536/114

(57) ABSTRACT

The invention relates generally to a guar gum with no perceptible grassy, green or beany flavor, low pigment and low micro both in partially hydrolyzed and non-hydrolyzed forms, as well as a process for making the same.

### CROSS REFERENCE TO RELATED APPLICATIONS

This application claims priority under 35 U.S.C. §119 to U.S. Provisional Patent Application No. 60/907,321 (filed Mar. 28, 2007), which application is expressly incorporated herein by reference in its entirety.

### BACKGROUND OF THE INVENTION

1. Field of the Invention

The invention relates generally to a non-grassy, non-beany, low pigment and low-micro guar gums both in non-hydrolyzed form and hydrolyzed forms to achieve various viscosity grades, as well as a process for making the same.

2. Related Art

Guar gum is a low cost all-purpose thickener that is used in variety of food applications as well as for industrial, cosmetic and pharmaceutical uses. Guar is a milled product produced from dried guar splits that is pre-soaked in approximately 0.5:1 to approximately 1.5:1 water to splits ratios to soften and partially open the molecules prior to milling. In many of its applications, the use of guar gum is restricted by the presence of a grassy, earthy, smell and beany, “green” flavor. In instant food products that are not heat-processed, specifically in instant drinks, fiber mixes or in dairy products with delicate taste attributes, these smell and taste are not acceptable. In addition, the traditional guar process does not remove its greenish yellow pigment that intensifies when the pH of the product is above 7.0. Moreover, the traditional guar process does not lower the microbial load of the finished powder making guar unsuitable for instant beverages and other cold-processed products.

A number of efforts have been made attempting to produce more functional guar gums. None of these efforts, however, provides non-grassy, non-beany, low pigment and low micro guar gums:

U.S. Patent Application Publication No. 2006-0045861 describes a composition of one cationic polygalactomannan or cationic derivatized polygalactomannan having a weight average molecular weight of 5,000 to 200,000 and having light transmittance in a 10% aqueous solution of greater than 80% at a wavelength of 600 nm, a protein content of less than 1% and a level of trimethylamine of less than 25 ppm in 10% aqueous solution of the polymer. The application discloses a process for removing odorous components such as trimethylamine and low molecular weight components from the cationic derivatized material that were introduced during the derivatization process.

U.S. Patent Application Publication No. 2006-0151173 describes a process for enhancing guar hydration rates and performing guar derivatization reactions. The process includes exposing guar splits to a chemical treatment to create treated guar splits and then, without first washing, grinding the treated guar splits into a powder. Thereafter, in another embodiment, the guar powder is placed in a treatment fluid into a portion of a subterranean formation.

U.S. Pat. No. 6,884,884 describes a method for depolymerizing galactomannans and their derivatives thereof.

U.S. Pat. No. 5,536,825 describes a process for derivatizing guar gum by treating the splits with 12 to 30 weight percent of aqueous base solution at a ratio of 120-140 parts of aqueous solution to 100 parts of splits, washing the splits with water, an organic solvent and mixture thereof, derivatizing the washed splits to introduce non-ionic, anionic and cationic groups in the guar molecule, and recovering the product that is produced from these steps. The guar produced with this process demonstrates greater than 75% light transmission at a wavelength of from about 500-600 nanometers when dispersed in water in the amount of 0.5 parts per 100 parts water, low protein content of less than 0.1% and low bacterial count.

U.S. Pat. No. 5,756,720 describes a process for further derivatizing non-ionically derivatized guar flour to produce polygalactomannans which contain both non-ionic and cationic groups that demonstrates greater than 75% light transmission at a wavelength of from about 500-600 nanometers when dispersed in water in the amount of 0.5 parts per 100 parts water. The process includes an alcohol or alcohol/water treatment, acid treatment, addition of cationic substituent, alkali treatment, washing with water, an organic solvent or a mixture thereof, and recovering the product.

U.S. Pat. No. 5,489,674 describes a process for producing guar gum that demonstrates greater than 75% light transmission at a wavelength of from about 500-600 nanometers when dispersed in water in the amount of 0.5 parts per 100 parts water. The process includes treating the splits with 12 to 30% aqueous base solution at a ratio of 120-140 parts aqueous base solution to 100 parts of splits, washing with water, organic solvent or a mixture thereof, and recovering the product produced.

U.S. Pat. No. 4,874,854 describes low viscosity heteropolysaccharides, for example, guar gum. Example 3 describes a “clarified” guar gum which is produced by cold filtration of a 0.3% solution through diatomaceous earth and precipitated with isopropyl alcohol.

U.S. Pat. No. 4,693,982 describes the use of enzymes to reduce insolubles in guar gum.

U.S. Pat. No. 4,659,811 describes a process for making alkaline refined guar and locust bean gum and use thereof in improved well-treating compositions. The process includes treating 100 parts of gum splits with at least about 150 parts by weight of a basic material sufficient to raise the pH of the aqueous solution to at least about 12, in an inert atmosphere and at a temperature of from about room temperature to about 110° C., for a period of at least about 0.25 hour. This same patent also describes novel hydraulic fracturing fluid compositions including (1) an aqueous medium, (2) alkali refined gum as a gelling agent, and (3) a breaker additive for subsequent reduction of fluid viscosity. The alkaline refining of the gum splits increases the viscosity of the gum so obtained by from about 20% to about 50%.

U.S. Pat. No. 3,912,713 describes non-lumping derivatives of guar gum produced by derivatizing guar gum splits at a moisture content of 20-80% by weight, raising the moisture content of the splits, if necessary, to 30-80% by weight and fragmenting the splits by pressing them out in a thin layer and drying them on a cylinder heated to 100° C.-180° C. and comminuting the film to form particulates of a size in the order of +20 mesh, as measured by a Tyler screen, and preferably having a size of 2-5 mm. This process is commonly referred to as drum drying. According to Example 3 of U.S. Pat. No. 3,912,713, the product produced gives a “clear solution having no lumps or clots on stirring in water.”

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates a functional block diagram of the steps of a process for preparing non-grassy, non-beany, low pigment and low micro guar gums that are partially hydrolyzed and non-hydrolyzed according to one embodiment of the invention;

FIG. 2 illustrates the typical GC-MS chromatograms of volatile aldehyde components of raw guar splits;

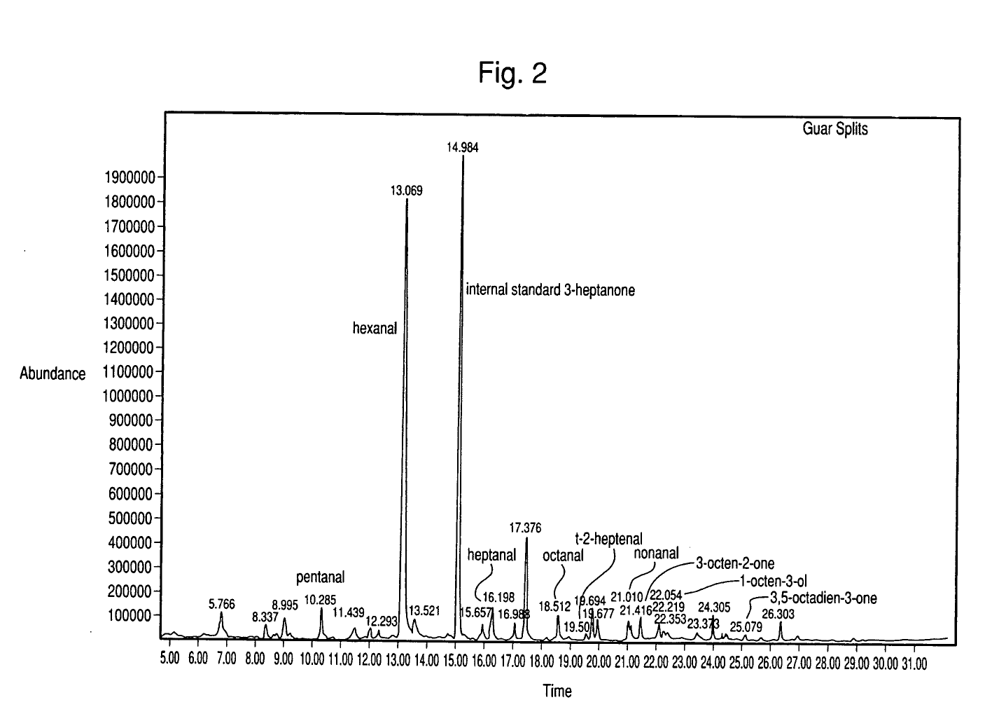

FIG. 3 illustrates the typical GC-MS chromatograms of the volatile aldehyde components of standard milled guar; and

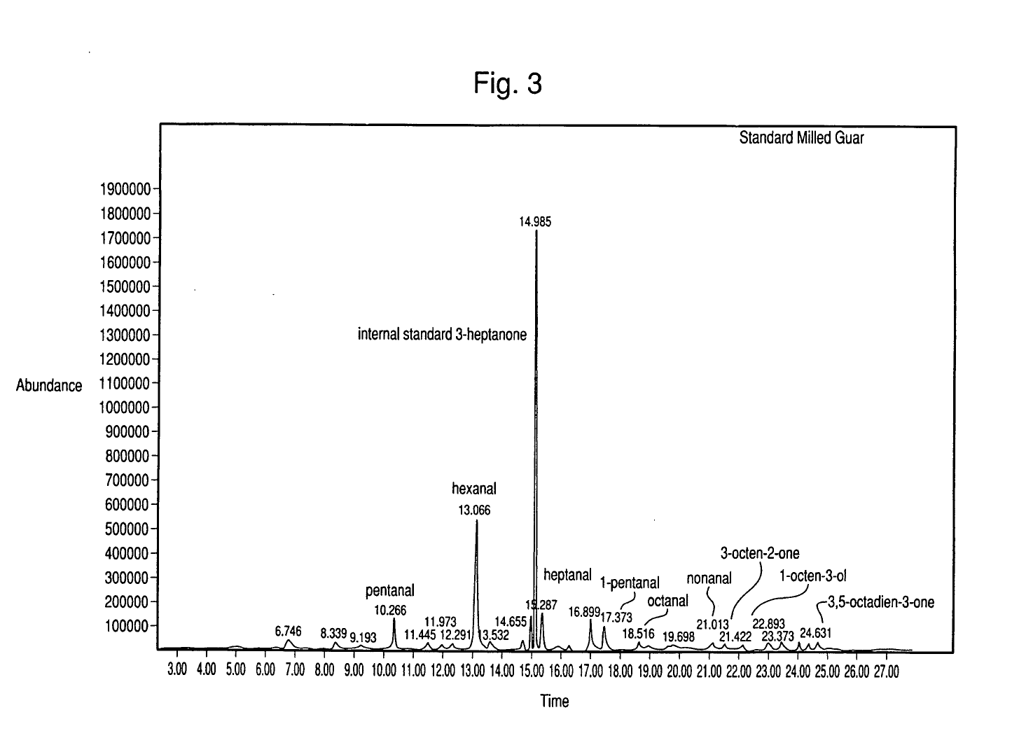

FIG. 4 illustrates the typical GC-MS chromatograms of the volatile aldehyde components of the guar gum of the invention.

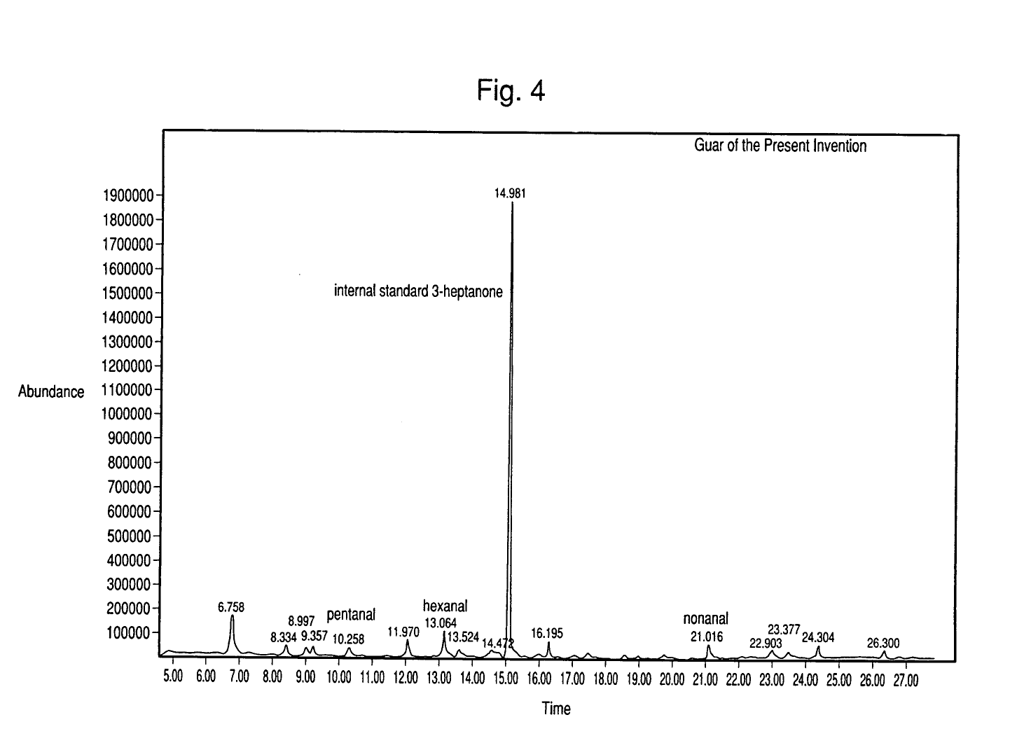

### SUMMARY OF THE INVENTION

The invention relates generally to a non-grassy, non-beany, low pigment and low micro guar gums both in non-hydrolyzed form and hydrolyzed forms to achieve various viscosity grades, as well as a process for making the same.

As noted above, guar is a low cost all-purpose thickener that is used in variety of food applications as well as for industrial, cosmetic and pharmaceutical uses. In many of its applications, however, the use of guar gum is restricted by the presence of a grassy, earthy smell and a beany, “green” taste. This grassy odor and beany taste from guar splits cannot be removed simply by rinsing the splits. Rather, the splits need to be properly swollen in water so that the water “sees” the odorous components and therefore can remove the odorous components out of the split by diffusion (i.e., by leaching). The swelling or water absorption of guar splits happens much faster than they take to dissolve and turn into a paste. This property allows the guar splits to be washed in order to remove the grassy odor and beany taste, reduce the greenish yellow pigment and produce a low micro guar powder.

The invention includes a process for preparing non-grassy, non-beany taste-free, odorless, low pigment and low micro guar gums, both non-hydrolyzed and hydrolyzed to achieve various viscosities, that includes the following steps:

Step 100. In step 100, the guar splits are soaked. In particular, the soaking can include water soaking guar splits at a ratio of at least approximately 300 parts of water to approximately 100 parts of guar splits; or alkaline soaking guar splits in an approximately 0.05% to approximately 0.20% alkali solution; or a combination thereof at a ratio of least approximately 300 parts alkali solution to approximately 100 parts of guar splits. The water or alkali solution can be at about room temperature up to boiling (or even above boiling temperatures), or could be introduced in the form of steam. Soaking time ranges from at least approximately 3 minutes depending on the temperature of the water or alkali solution. When treated according to this step of the invention, the guar splits will have swollen or increased to approximately at least 3 times in volume. In one embodiment, for example, water at approximately 150° F.-155° F. can be used for about seven (7) minutes to achieve a suitable volume expansion. In another embodiment, the use of a low dose of alkali helps remove most of the yellowish-green pigment from the guar splits. Afterward, the guar splits are drained of excess water or alkali solution.

Step 200. In step 200, the guar splits of step 100 are washed at least one or more times with water at a ratio of at least approximately 300 parts water to approximately 100 parts of guar splits for a contact or soaking time of at least approximately 1 minute before draining. The water temperature ranges from approximately room temperature up to approximately boiling and beyond.

Step 300. Step 300 is not required if producing non-hydrolyzed, standard viscosity guar gum; otherwise in step 300, the guar splits are reacted with up to 30% of a hydrolyzing agent based on the dry weight of the guar splits for approximately at least 5 minutes. This said hydrolyzing step may be done prior to step 100 or prior to soaking and subsequent washing steps to achieve the same effect. This said hydrolyzing step is not required if producing non-hydrolyzed or standard viscosity guar gum.

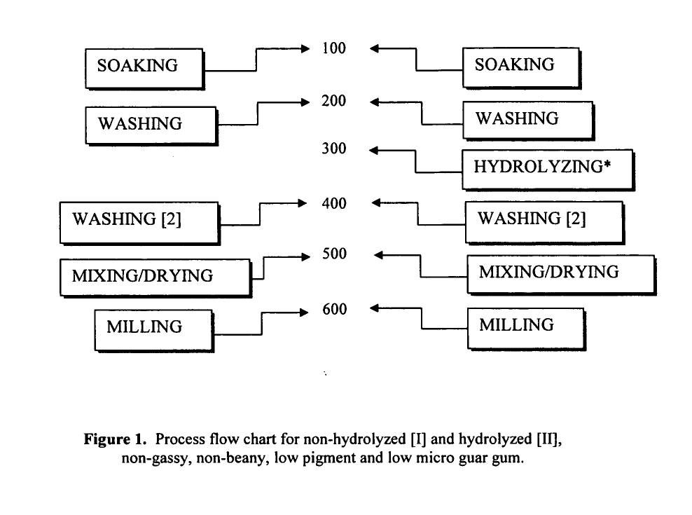

Step 400. As applicable when alkali soaking is used in step 100, in step 400 the guar splits of either step 200 or step 300 are washed with a water solution that includes an acid component (e.g., citric, malic, phosphoric, lactic, propionic and other acids, or a mixtures thereof) at a total acid concentration of at least approximately 0.1%, and an anti-microbial agent such as potassium sorbate, sodium benzoate and other food approved preservatives at least approximately 0.001% in water and temperatures from approximately room temperature to boiling and beyond at ratio of the final wash solution of at least approximately 300 parts to approximately 100 parts of the guar splits. The acid mixtures, thereof, is used to neutralize the residual alkali in the soaked splits, and the anti-microbial agent is used to prevent microbial growth while the splits are still wet prior to drying. As indicated in FIG. 1 (by the symbol “•”), this hydrolyzing step can also be optionally be performed prior to soaking in water and alkali.

Step 500. In step 500, the washed and drained splits are then heated, mixed, and allowed to absorb all the surface water until free flowing, or pre-dried until free-flowing using any suitable mechanical drying techniques, or precipitated by alcohol to remove excess water, heated and mixed until free flowing.

Step 600. In step 600, the guar splits are milled to a fine powder.

The invention further includes guar gums with varying viscosities as shown in Table 1 that do not have the grassy and beany taste and have a low pigment and low microbial load. In particular, the guar gum of the invention contains non-perceptible concentrations of volatile aldehydes as opposed to the standard milled guar. As shown in the GC-MS chromatogram in FIG. 24, the guar gums of the invention (and the processes for making the same) exhibit a dramatically reduced content of hexanal, a compound responsible for the green, grassy off-odor that seemed to be the major component of the guar volatiles, and significantly reduced pentanal and nonanal levels (which are likewise contributors to the grassy characteristics of other guar gums). The guar gums and processes of the invention also have completely eliminated 3-octen-2-one, 1-octen-3-ol and 3,5-octadiene-2-one, the other volatile aldehydes that contribute to grassy, earthy, mushroom off-flavor. Table 2 compares the concentration of the volatile aldehydes as measured using the following method: two grams sample was placed in a purge-trap tube, and 5 ul of 3-heptanone (0.1 mg/mL in methanol internal standard) was added. The samples were analyzed with dynamic headspace-GC-MS. The concentration was calculated based on peak area of aldyhydes and internal standard of 3-heptanone. Comparing guar of the invention to the standard milled guar, the hexanal concentration was reduced by at least approximately 66% and the total volatile aldehydes by at least approximately 62%; and comparing to the raw guar splits, the hexanal reduction was at least approximately 88% and the total volatile reduction was at least approximately 84%.

In addition, the guar gums and the processes of the invention exhibit significantly lowered quantities of the greenish yellow pigment and lowered microbial load of the finished product, as shown in Table 1. The L, a and b values at pH 9-10, where the guar pigment is most intense, distinctly differentiate the color of regular guar versus the guar gum of the invention; the guar of the invention has a higher L or lightness value, a lower b or yellow value and less green as shown by a less negative value for a. The total plate count for the guar of the invention was typically <200/g and yeast mold count was below the detection limit of <100 cfu/g using the standard BAM method. Using descriptive flavor analysis done by a third party laboratory, a 1% solution of the various guar gums of the invention did not give earthy/dirty/raw/green flavor or a score of 0 versus 7 for the guar splits for this same attribute. The regular guar exhibited the earthy/dirty/raw/green flavor that was present in the guar splits with a score of 4.

TABLE 1
Viscosities of non-hydrolyzed and partially hydrolyzed,
non-grassy, non-beany, odor-free, low pigment and low micro
guar gum.

| | Typical Viscosity, | |
|---|---|---|
| Sample | cP [Average] | |
| Non-Hydrolyzed Guar | 4000-5000 | cP at 1% |
| Hydrolyzed Before Washing Step | | |
| 3% of Hydrolyzing Agent | 1450 | cP at 2% |
| 13% of Hydrolyzing Agent | 125 | cP at 2% |
| >15% of Hydrolyzing Agent | <25 | cP at 2% |
| Hydrolyzed After Washing Step | | |
| 2.5% of Hydrolyzing Agent | 5100 | cP at 2% |
| 4.9% of Hydrolyzing Agent | 894 | cP at 2% |
| 9.8% of Hydrolyzing Agent | 516 | cP at 2% |
| 12.3% of Hydrolyzing Agent | 180 | cP at 2% |
| 14.7% of Hydrolyzing Agent | 126 | cP at 2% |
| 17.2% of Hydrolyzing Agent | 113 | cP at 2% |
| >20% of Hydrolyzing Agent | <25 | cP at 2% |

TABLE 2
Volatile aldehydes concentrations in ppb [ug/kg] of the guar of the
invention, the standard milled guar and raw guar splits

| | | | Standard | Guar of the Invention | | | |
|---|---|---|---|---|---|---|---|
| | | Guar | Milled | Sample | Sample | Sample | Sample |
| Time | Samples | Splits | Guar | 1 | 2 | 3 | 4 |
| 10.285 | pentanal | 24 | 27 | 8 | 7 | 10 | 6 |
| 13.069 | hexanal | 284 | 103 | 28 | 35 | 33 | 22 |
| 15.857 | heptanal | 13 | 7 | 7 | 5 | 7 | nd |
| 18.512 | octanal | 15 | 5 | 4 | 6 | 6 | 3 |
| 19.501 | t-2-heptenal | 5 | 2 | nd | nd | nd | nd |
| 21.01 | nonanal | 24 | 14 | 9 | 9 | 8 | 9 |
| 21.416 | 3-octen-2-one | 15 | 5 | nd | nd | nd | nd |
| 22.054 | 1-octen-3-ol | 16 | 4 | nd | nd | nd | nd |
| 25.079 | 3,5-octadiene-2-one | 4 | 2 | nd | nd | nd | nd |
| | TOTAL | 400 | 169 | 56 | 61 | 64 | 40 |

TABLE 3
Typical quality attributes of the guar gum of the invention

| Quality Parameter | Typical Result |
|---|---|
| Total Plate Count | <200/g |
| E. coli | Negative |
| Salmonella | Negative/25 g |
| Yeast & Mold | <100/g |
| Earthy/Beany/Green Flavor | Absent |
| Earthy/Dirty/Raw/Green Flavor Score | 0 vs. 4.0 for control guar |
| | or 7.0 for raw splits |
| Color at alkaline pH (9-10) | |
| L | 54 vs. 42 for control guar |
| a | −0.02 vs. −0.41 for control guar |
| b | 7.3 vs. 12.2 for control guar |

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

What is claimed is:

1. A guar gum comprising a reduced volatile aldehyde content.

2. The guar gum of claim 1, wherein said reduce volatile aldehyde content is reduced by at least approximately 62% relative to standard milled guar gum.

3. The guar gum of claim 1, wherein said reduce volatile aldehyde content is reduced by at least approximately 84% relative to raw guar splits.

4. The guar gum of claim 1, wherein said guar gum is substantially free of at least one of 3-octen-2-one, 1-octen-3-ol, 3,5-octadiene-2-one and combination thereof.

5. The guar gum of claim 1, wherein said guar gum is at least one of non-hydrolyzed, partially hydrolyzed and fully hydrolyzed.

6. The guar gum of claim 1, wherein said guar gum has a viscosity in the range of less than approximately 25 cP at approximately equal or greater than 2% gum concentration to less than approximately 6500 cP at approximately 1% gum concentration.

7. A guar gum comprising a reduced hexanal content.

8. The guar gum of claim 7, wherein said reduce hexanal content is reduced by at least approximately 66% relative to standard milled guar gum.

9. The guar gum of claim 7, wherein said reduce hexanal content is reduced by at least approximately 88% relative to raw guar splits.

10. The guar gum of claim 7, wherein said guar gum is substantially free of at least one of 3-octen-2-one, 1-octen-3-ol, 3,5-octadiene-2-one and combination thereof.

11. The guar gum of claim 7, wherein said guar gum is at least one of non-hydrolyzed, partially hydrolyzed and fully hydrolyzed

12. The guar gum of claim 7, wherein said guar gum has a viscosity in the range of less than approximately 25 cP at approximately equal or greater than 2% gum concentration to less than approximately 6500 cP at approximately 1% gum concentration.

13. A guar gum comprising a reduced volatile aldehyde content and a reduced hexanal content.

14. The guar gum of claim 13, wherein said reduce volatile aldehyde content is reduced by at least approximately 62% relative to standard milled guar gum and at least approximately 84% relative to raw guar splits.

15. The guar gum of claim 13, wherein said reduce hexanal content is reduced by at least approximately 66% relative to standard milled guar gum and at least approximately 88% relative to standard milled guar gum.

16. The guar gum of claim 13, wherein said guar gum is substantially free of at least one of 3-octen-2-one, 1-octen-3-ol, 3,5-octadiene-2-one and combination thereof.

17. The guar gum of claim 13, wherein said guar gum is at least one of non-hydrolyzed, partially hydrolyzed and fully hydrolyzed

18. The guar gum of claim 13, wherein said guar gum has a viscosity in the range of less than approximately 25 cP at approximately equal or greater than 2% gum concentration to less than approximately 6500 cP at approximately 1% gum concentration.

19. A process for preparing a guar gum having at least one of (i) a reduced volatile aldehyde content and (ii) a reduce hexanal content comprising:
i. soaking guar splits;
ii. washing said guar splits;
iii. optionally hydrolyzing said guar splits to achieve lower guar viscosities;
iv. optionally neutralizing or acidifying said guar splits;
v. partial drying or removing excess liquid from said guar splits; and
vi. milling said guar splits.

20. The process of claim 19, wherein said soaking of said guar splits comprises at least one of (i) water soaking at a ratio of at least approximately 300 parts of water to approximately 100 parts of guar splits, (ii) alkaline soaking guar splits in an approximately 0.05% to approximately 0.20% alkali solution and (iii) a combination thereof at a ratio of least approximately 300 parts alkali solution to approximately 100 parts of guar splits.

21. The process of claim 19, wherein said soaking of said guar splits occurs from approximately room temperature to above boiling temperature.

22. The process of claim 19, wherein said soaking of said guar splits occurs for at least approximately 2 minutes.

23. The process of claim 19, wherein said washing comprises at least one washing step using water at a ratio of at least approximately 300 parts water to approximately 100 parts of guar splits for at least approximately 1 minute.

24. The process of claim 19, wherein said optionally hydrolyzing of guar splits comprises using at least one hydrolyzing agent at a concentration of at least approximately 1%.

25. The process of claim 19, wherein said optionally hydrolyzing of guar splits occurs prior to said soaking step.

26. The process of claim 19, wherein said optionally neutralizing or acidifying of said guar splits comprises treatment with at least one acid component.

27. The process of claim 26, wherein said at least one acid component is at least one of citric acid, malic acid, phosphoric acid, lactic acid, propionic aid and combinations thereof.

28. The process of claim 26, wherein said at least one acid component has a total acid concentration of at least approximately 0.1%.

29. The process of claim 26, wherein said optionally neutralizing or acidifying of said guar splits further comprises at least one washing step comprising at least one anti-microbial agent.

30. The process of claim 29, wherein said at least one anti-microbial agent is at least one of potassium sorbate, sodium benzoate and combinations thereof.

31. The process of claim 29, wherein said at least one anti-microbial agent is at a concentration of at least approximately 0.001%.

32. The process of claim 29, wherein said at least one anti-microbial agent is at a concentration sufficient to preserve said guar splits until said guar splits are dried and milled.

33. The process of claim 19, wherein said partial drying or removing excess liquid from said guar splits comprises at least one of (i) heating and mixing said guar splits at a sufficient temperature and for a sufficient time in order to absorb substantially all surface water until free flowing; (ii) heating said guar splits with at least one of a drum dryer, flaker or tunnel oven dryer; (iii) soaking said guar splits in at least 10% alcohol.

34. The process of claim 33, wherein said alcohol is at least one of ethyl alcohol, isopropyl alcohol and combination thereof.
